(19) United States
(12) Patent Application Publication
(10) Pub. No.: US 2017/0056735 A1
(43) Pub. Date: Mar. 2, 2017

(54) POCKETED TOWEL MADE OF A PLURALITY OF FABRICS

(71) Applicants: Charles Nevin, Rogers, AR (US); Bart Schaller, Rogers, AR (US)

(72) Inventors: Charles Nevin, Rogers, AR (US); Bart Schaller, Rogers, AR (US)

(21) Appl. No.: 15/244,201

(22) Filed: Aug. 23, 2016

Related U.S. Application Data
(60) Provisional application No. 62/209,668, filed on Aug. 25, 2015.

(51) Int. Cl. A63B 57/60; B32B 3/26; B32B 5/02

(52) U.S. Cl. CPC A63B 57/60; B32B 5/02; B32B 3/266; B32B 2555/00

(57) ABSTRACT

A towel having a first portion fabricated from a first fabric and a second portion fabricated from a second fabric, the first portion being coupled to the second portion, the second portion having a pocketed section. In a preferred embodiment, the first portion is generally a quadrilateral shape, having four corners and the second portion is generally a quadrilateral shape having four corners. The third corner of the first portion overlaps with, and is stitched to, the first corner of the second portion. In a further embodiment, the pocketed corner extends longitudinally across the bottom of the second portion. In an embodiment, the first fabric is microfiber and the second fabric is Terry cloth. In a further embodiment, the first fabric is Terry cloth and the second fabric is microfiber.

### CROSS-REFERENCE TO RELATED APPLICATION

This application claims priority to U.S. Provisional Application Ser. No. 62/209668, filed Aug. 25, 2015 entitled: POCKETED TOWEL MADE OF A PLURALITY OF FABRICS, the contents of each of which are incorporated herein by reference.

### FIELD OF THE INVENTION

The invention relates to pocketed sports and outdoor activities towels and textiles comprised of a plurality of fabrics, used, for example, in connection with the game of golf and other sport activities.

### BACKGROUND

Microfiber is a synthetic fiber finer than one denier or decitex. One denier or decitex is smaller than the diameter of a strand of silk, which is itself about ⅕ the diameter of a human hair. The most common types of microfibers are made from polyesters, polyamides, nylon, or a conjugation of polyester, polyamide, and polypropylene. Microfiber is used to make mats, knits, and weaves for apparel, upholstery, industrial filters, and cleaning products. The shape, size, and combinations of synthetic fibers are selected for specific characteristics, including softness, toughness, absorption, water repellency, electrostatics, and filtering capabilities. Microfiber material is useful in connection with sports and outdoor activities as it wicks moisture such as perspiration away from the body.

Terry cloth is a fabric with loops that can absorb large amounts of water. It can be manufactured by weaving or knitting. Terry cloth is woven on special looms that have two beams of longitudinal warp through which the filler or weft is fired laterally. Terry towel is a woven fabric with long loops that can absorb large amounts of water. Its content is usually 100% cotton, but may sometimes contain polyester. The length of loops determines how much fluid is absorbed by the cloth as longer loops provide more surface area to absorb and come in contact with the fluid.

### SUMMARY OF THE INVENTION

A towel having a first portion fabricated from a first fabric and a second portion fabricated from a second fabric, the first portion being coupled to the second portion, the second portion having a pocketed section. In a preferred embodiment, the first portion generally a quadrilateral shape, having four corners and the second portion is generally a quadrilateral shape having four corners. The third corner of the first portion overlaps with, and is stitched to, the first corner of the second portion. In a further embodiment, the pocketed corner extends longitudinally across the bottom of the second portion. In an embodiment, the first fabric is microfiber and the second fabric is Terry cloth. In a further embodiment, the first fabric is Terry cloth and the second fabric microfiber.

### BRIEF DESCRIPTION OF THE DRAWING

Other features of the invention will become clear from the following description, taken together with the accompanying drawing.

FIG. 1 is a plan view of a first embodiment of the invention; and

FIG. 2 is a plan view of a second embodiment of the invention.

### DESCRIPTION OF THE INVENTION

While the making and using of the preferred embodiments of the present invention is discussed in detail below, it should be appreciated that the present invention provides many applicable inventive concepts which can be embodied a wide variety of specific contexts. Some features of the preferred embodiment shown and discussed may be simplified or exaggerated for illustrating the principles of the invention.

The present invention comprises a towel having a first portion fabricated from a first fabric and a second portion fabricated from a second fabric, the first portion being coupled to the second portion, the second portion having a pocketed section. In a preferred embodiment, the first portion is generally a quadrilateral shape, having four corners and the second portion is generally a quadrilateral shape having four corners. The third corner of the first portion overlaps with, and is stitched to, the first corner of the second portion. In a further embodiment, the pocketed corner extends longitudinally across the bottom of the second portion. A further embodiment comprises a plurality of pockets arranged about and in different dimensions on either or both of the fabric portions. In an embodiment, the first fabric is microfiber and the second fabric is Terry cloth. In a further embodiment, the first fabric is Terry cloth and the second fabric is microfiber.

This invention provides the user a first fabric portion operable to keep hands and face free from sweat or water and a second fabric portion that is water absorbent that remains moist to clean sports and outdoors equipment, such as, but not limited to, golf clubs, grips and golf balls. The first fabric portion may be microfiber and the second portion may be Terry cloth. A pouch or pocketed section proximate the bottom of one of the fabric portions, for example, a pocketed section at the at bottom of microfiber side, acts to catch golf balls or insert club heads in for ease of cleaning. The intersection of the attached, overlapping portions of the first fabric portion and second fabric portion serves as a connection point to hang the towel on, inter alia, a golf bag, golf cart, over a user's shoulder or neck. An aperture can be provided within the overlapping connection point to better secure the towel to a hook or similar hanging fixture.

In a preferred embodiment, the first fabric portion and second fabric portion are equally dimensioned. The microfiber portion of the towel is extra-absorbent for absorbing and retaining water so as to be used to clean sports and outdoors equipment and grips. A pocket sewn in on the micro giber portion allows the user to clean all sides of a golf ball or golf club or other piece of equipment. The Terry cloth portion of the towel is soft and absorbent for wiping sweat and water off face, neck, hands and arms.

In a preferred embodiment, the separate fabric portions allow the use of different colors and/or patterns representing a user's preferred sports team. The invention can further be used in a variety of contexts, including racket sports such as tennis, squash, and racquetball, baseball, softball, sailing and auto care.

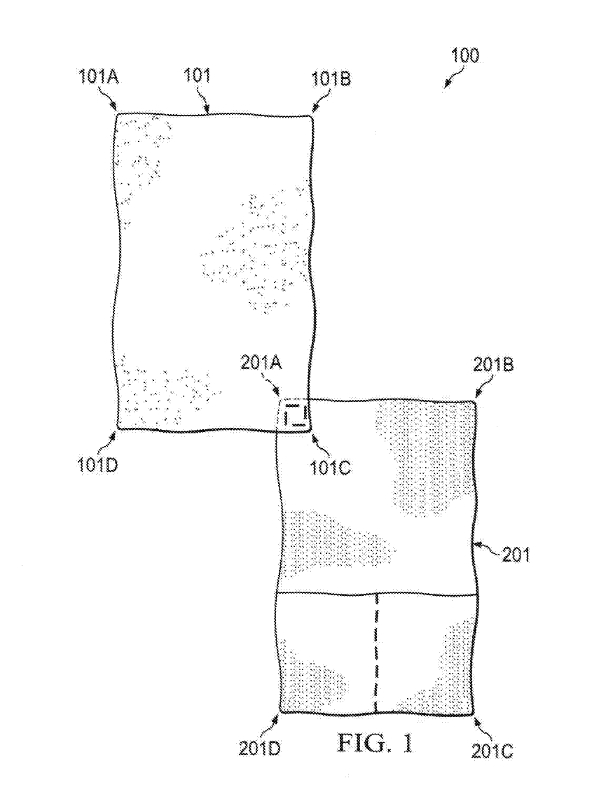

As noted, the relationship of the parts of the invention are with reference to generally quadrilateral fabric shapes, such as a rectangle. As seen in FIG. 1, the invention 100 comprises a first fabric portion 101 and second fabric portion 201, each dimensioned as a rectangle, being substantially planar and having a front and back, and a perimeter comprising a top edge, right edge, bottom edge, and left edge. The first portion 101 has a first corner 101A, a second corner 102B, third corner 103B and fourth corner 104B. The second portion 201 has a first corner 201A, a second corner 202B, third corner 203B and fourth corner 204B. In a first orientation of the first portion, the top edge and bottom edge are substantially equal in length but have lengths that are shorter than the right edge and left edge, both of which are substantially equal in length. In a second orientation, the top edge and bottom edge have lengths that are longer than the right edge and left edge. In a first orientation of the second portion, the top edge and bottom edge are substantially equal in length but have lengths that are shorter than the right edge and left edge, both of which are substantially equal in length. In a second orientation, the top edge and bottom edge have lengths that are longer than the right edge and left edge. The first fabric and second fabric are overlapped at a corner of each and stitched at a connection point 301.

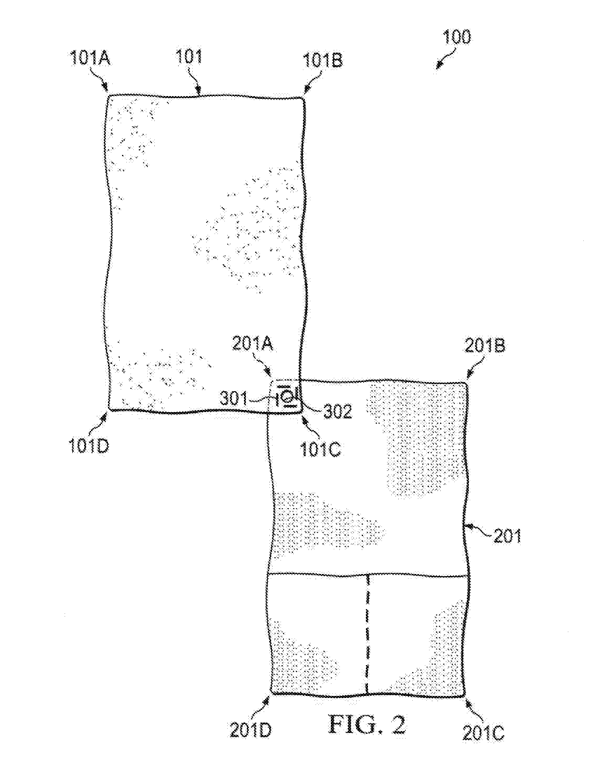

As seen in FIG. 2, connection point 301 includes an aperture 302 operable to allow the towel to be affixed to a hanger or other apparatus.

Additional embodiments of the invention include a towel having a first portion fabricated from a first fabric and a second portion fabricated from a second fabric. The first portion is coupled to the second portion and the second portion has a pocketed section. The first portion is a generally a quadrilateral shape, having a first portion first corner, a first portion second corner, a first portion third corner, and a first portion fourth corner; and further wherein the second portion is generally a quadrilateral shape having a second portion first corner, a second portion second corner, a second portion third corner, and a second portion fourth corner. The first portion third corner overlaps with the second portion first corner to form an overlapping portion, the first portion third corner being coupled via stitching at the second portion first corner.

In a further embodiment, the pocketed corner extends longitudinally across the bottom of the second portion from the second portion fourth corner across to the second portion third corner and can comprise a plurality of dimensioned pockets.

As noted, the first fabric is microfiber and the second fabric is Terry cloth or vice versa. The embodiment includes a connection, point where the first fabric portion and second fabric portion are affixed having an aperture there-through. In this embodiment, the dimensions of the first portion are substantially equivalent to the dimensions of the second portion. In further embodiments, the first portion is a substantially rectangular shape and the second portion is a substantially square shape, alternatively, the first portion is a substantially square shape and the second portion is a substantially rectangular shape.

Another embodiment is a golf towel having a first portion being a flexible planar fabric fabricated from Terry cloth material and a second portion being a flexible planar portion fabric fabricated from a microfiber material. The first portion is coupled to the second portion and the second portion has a pocketed section, wherein the first portion is generally a square shape, having a first portion first corner, a first portion second corner, a first portion third corner, and a first portion fourth corner; and further wherein the second portion is generally a square shape having a second portion first corner, a second portion second corner, a second portion third corner, and a second portion fourth corner. In this embodiment, the first portion third corner overlaps with the second portion first corner to form an overlapping portion, the first portion third corner being coupled via stitching at the second portion first corner.

In a further aspect of this embodiment, the pocketed corner extends longitudinally across the bottom of the second portion from the second portion fourth corner across to the second portion third corner and can be a single pocket or a plurality of dimensioned pockets within the second portion. There can be included a connection point where the first fabric portion and second fabric portion are affixed.

In yet a further aspect, the invention is a towel having a first portion being a flexible planar fabric fabricated from Terry cloth material and a second portion being a flexible planar portion fabric fabricated from a microfiber material, the second portion having a pocketed section. A section of the first portion overlaps with a section of the second portion to form an overlapping portion, the first portion overlapping the second portion being coupled via stitching thereto.

In further embodiment, the first portion and second portion are generally oval shaped. In yet, further embodiment, the first portion and second portion are generally circular shaped. In yet a further embodiment, the first portion and second portion are generally rectangular shaped having rounded corners. In yet a further embodiment, the first portion and second portion are generally square shaped having rounded corners. In any of the foregoing embodiments, there is a connection point where the first fabric portion and second fabric portion are affixed include an aperture there-through.

As the parts of the invention are made of fabric, the thickness of the invention is de-minimis when compared to the length and width of the fabric, although one skilled in the art would recognize that some material, such as Terry cloth, is thicker than cloth linen or microfiber, each of which fabrics can be used in making the invention. The use of the foregoing designations are merely to show the relative positions of the different portions of the invention with respect to the other and are not to be construed as limiting the invention.

A first preferred embodiment of the invention includes a first portion having dimensions of 15 inches in length (top edge and bottom edge) by 20 inches in length (right edge and left edge) and a second portion having dimensions of 15 inches (top edge and bottom edge) in length by 20 inches (right edge and left edge) in length, although those dimensions are not meant to be limiting.

A second preferred embodiment of the invention includes a first portion having dimensions of 20 inches in length (top edge and bottom edge) by 20 inches in length (right edge and left edge) and a second portion having dimensions of 20 inches (top edge and bottom edge) in length by 20 inches (right edge and left edge) in length, although those dimensions are not meant to be limiting.

A third preferred embodiment of the invention includes a first portion having dimensions of 18 inches in length (top edge and bottom edge) by 24 inches in length (right edge and left edge) and a second portion having dimensions of 18 inches (top edge and bottom edge) in length by 24 inches (right edge and left edge) in length, although those dimensions are not meant to be limiting.

A fourth preferred embodiment of the invention includes a first portion having dimensions of 12 inches in length (top edge and bottom edge) by 12 inches in length (right edge and left edge) and a second portion having dimensions of 12 inches (top edge and bottom edge) in length by 12 inches (right edge and left edge) in length, although those dimensions are not meant to be limiting.

For example, each of the first portion and second portion may include a top edge of between 6 inches and 30 inches in length, a bottom edge of between 6 inches and 30 inches in length, a right edge of between 6 inches and 30 inches in length and a left edge of between 6 inches and 30 inches in length.

The embodiments shown and described herein are only exemplary. Even though characteristics and advantages of the present invention have been set forth in the foregoing description together with details of the invention, the disclosure is illustrative only and changes may be made within the principles of the invention to the full extent indicated by the broad general meaning of the terms used in the attached claims.

What we claim is:

1. A towel, comprising:
a first portion fabricated from a first fabric;
a second portion fabricated from a second fabric;
the first portion coupled to the second portion, the second portion having a pocketed section.

2. The towel of claim 1, wherein the first portion is generally a quadrilateral shape, having a first portion first corner, a first portion second corner, a first portion third corner, and a first portion fourth corner; and further wherein the second portion is generally a quadrilateral shape having a second portion first corner, a second portion second corner, a second portion third corner, and a second portion fourth corner; and
wherein the first portion third corner overlaps with the second portion first corner to form an overlapping portion, the first portion third corner being coupled via stitching at the second portion first corner.

3. The towel of claim 2, wherein the pocketed corner extends longitudinally across the bottom of the second portion from the second portion fourth corner across to the second portion third corner.

4. The towel of claim 2, comprising a plurality of dimensioned pockets.

5. The towel of claim 1, wherein the first fabric microfiber and the second fabric is Terry cloth.

6. The towel of claim 1, wherein the first fabric is Terry cloth and the second fabric is microfiber.

7. The towel of claim 1, including a connection point where the first fabric portion and second fabric portion are affixed having an aperture therethrough.

8. The towel of claim 1, wherein the dimensions of the first portion are substantially equivalent to the dimensions of the second portion.

9. The towel of claim 1, wherein the first portion is substantially rectangular shape and the second portion is substantially square shape.

10. The towel of claim 1, wherein the first portion is a substantially square shape and the second portion is a substantially rectangular shape.

11. A golf towel, comprising:
a first portion being a flexible planar fabric fabricated from Terry cloth material;
a second portion being a flexible planar portion fabric fabricated from a microfiber material;
the first portion coupled to the second portion, the second portion having a pocketed section, wherein the first portion is generally a square shape, having a first portion first corner, a first portion second corner, a first portion third corner, and a first portion fourth corner; and further wherein the second portion is generally a square shape having a second portion first corner, a second portion second corner, a second portion third corner, and a second portion fourth corner; and
wherein the first portion third corner overlaps with the second portion first corner to form an overlapping portion, the first portion third corner being coupled via stitching at the second portion first corner.

12. The towel of claim 11, wherein the pocketed corner extends longitudinally across the bottom of the second portion from the second portion fourth corner across to the second portion third corner.

13. The towel of claim 11, comprising a plurality of dimensioned pockets within the second portion.

14. The towel of claim 11, including a connection point where the first fabric portion an second fabric portion are affixed.

15. A towel, comprising:
a first portion being a flexible planar fabric fabricated from Terry cloth material;
a second portion being a flexible planar portion fabric fabricated from a microfiber material, the second portion having a pocketed section; and
wherein a section of the first portion overlaps with a section of the second portion to form an overlapping portion, the first portion overlapping the second portion being coupled vie stitching thereto.

16. The towel of claim 15, wherein the first portion and second portion are generally oval shaped.

17. The towel of claim 15, wherein the first portion and second portion are generally circular shaped.

18. The towel of claim 15, wherein the first portion and portion are generally rectangular shaped having rounded corners.

19. The towel of claim 15, wherein the first portion and second portion are generally square shaped having rounded corners.

20. The towel of claim 15, including a connection point where the first fabric portion and second fabric portion are affixed include an aperture there-through.
